(19) United States
(12) Patent Application Publication
(10) Pub. No.: US 2021/0040279 A1
(43) Pub. Date: Feb. 11, 2021

(54) METHOD OF PREPARING POLYIMIDE FILM AND DISPLAY PANEL

(71) Applicant: SHENZHEN CHINA STAR OPTOELECTRONICS SEMICONDUCTOR DISPLAY TECHNOLOGY CO., LTD, Guangdong (CN)

(72) Inventor: Li ZHANG, Guangdong (CN)

(21) Appl. No.: 16/612,412

(22) PCT Filed: Sep. 25, 2019
(86) PCT No.: PCT/CN2019/107657

§ 371 Date: Nov. 11, 2019

(30) Foreign Application Priority Data
Aug. 9, 2019 (CN) 201910732538.4

(51) Int. Cl. C08J 5/18; C08G 73/10

(52) U.S. Cl. CPC C08J 5/18; C08J 2379/08; C08G 73/1032

(57) ABSTRACT

A method of preparing a polyimide film, comprising: dissolving an aromatic diamine monomer in a solvent, adding a silane coupling agent, stirring uniformly, and further adding a dianhydride monomer to carry out polycondensation to obtain a polyamic acid solution; oating the polyamic acid solution on a glass substrate, followed by drying, and then carrying out a thermal imidization under vacuum, and naturally cooling to room temperature to obtain the polyimide film. As such, adhesion between the polyimide and the substrate can be enhanced, thereby improving a problem of separation of the two substrates due to poor adhesion.

### BACKGROUND OF INVENTION

### Field of Invention

The present invention relates to a field of display technology, and in particular, to a method of preparing a polyimide film and a display panel.

### Description of Prior Art

For flexible display screens, traditional glass substrates have failed to meet the flexibility requirements for curvature, and most of them are replaced by plastic substrates. However, in a display manufacturing process, temperatures of some processes are as high as 350° C., and a temperature of a low temperature poly-silicon (LTPS) process is even higher than 400° C., which puts higher requirements on heat resistance of materials. Polyimide is the best choice for flexible display substrates due to its glass transition temperature of up to 400° C., excellent mechanical properties, and dimensional stability.

For a flexible liquid crystal display (LCD), since it is still necessary to realize the display by utilizing optical properties of liquid crystals, a flexible substrate having excellent transmittance is required. A conventional yellow polyimide material cannot satisfy the requirement of transmittance, and thus a colorless transparent polyimide material is used as a flexible substrate because its transmittance is as high as 90%. The colorless transparent polyimide material is mostly prepared by polymerization of a diamine monomer and an acid anhydride monomer, and most studies have adopted a strong electronegativity of F atoms by introducing a —CF3 group into a chain of a polyimide molecular, to destroy a charge-transfer complex (CTC) between an electron donor and an electron acceptor to prepare the colorless transparent polyimide.

Since a substrate made of a flexible material has weaker bearing capacity, which will eventually affect the effectiveness of processes. Therefore, the flexible substrate is generally attached to a rigid substrate, and after the process is completed, the flexible substrate is peeled off from the rigid substrate. However, in the preparation process, adhesion between the polyimide film and the substrate is poor, which may cause a risk of separation of the two substrates.

### SUMMARY OF INVENTION

The present invention provides a method of preparing a polyimide film and a display panel, so as to solve the existing problem that when a polyimide film is prepared on a rigid substrate, adhesion between an upper and a lower substrates is poor, causing separation of the polyimide film from the rigid substrate, thereby impacting performance of the polyimide film.

In order to solve the above problems, the technical solution provided by the present invention is as follows:

The present invention provides a preparation method of a polyimide film, comprising the following steps:

step S10, dissolving at least one kind of aromatic diamine monomer in a polar aprotic organic solvent, adding a silane coupling agent, and stirring uniformly to form a homogeneous solution, wherein the aromatic diamine monomer has a molecular structural formula as shown in Formula (1):

H₂N—R₁—NH₂ (1)

step S20, adding at least one dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2):

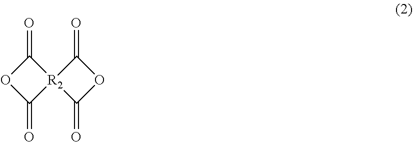

and the polyamic acid has a molecular structural formula as shown in Formula (3):

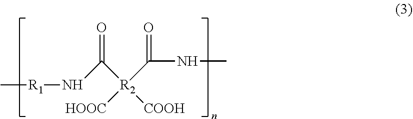

wherein n is a positive integer;

step S30, coating the polyamic acid solution on a glass substrate, followed by drying, and then carrying out thermal imidization under vacuum, and naturally cooling to room temperature to obtain the polyimide film, wherein the polyimide has a molecular structural formula as shown in formula (4):

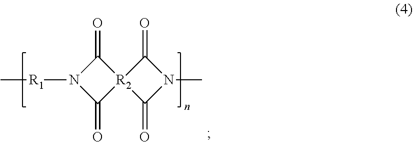

R₁ is selected from one of the following molecular structural formulae:

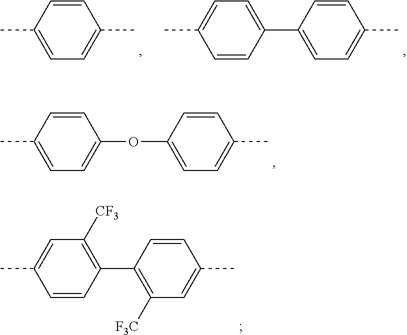

R₂ is selected from one of the following molecular structural formulae:

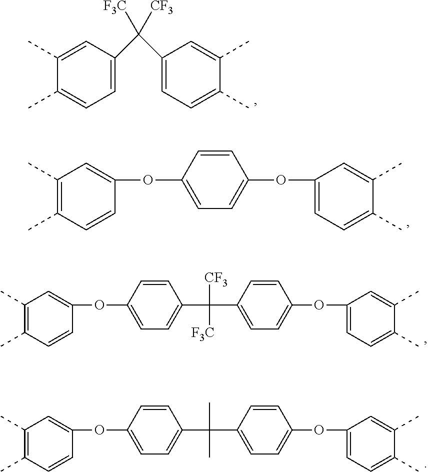

In an embodiment of the present invention, in the step S20, the dianhydride monomer is added to the homogeneous solution in 3 to 8 times, and the dianhydride monomer and the aromatic diamine monomer are reacted at room temperature for 8 to 20 hours.

In an embodiment of the present invention, in the step S30, the polyamic acid solution is filtered with a 300-500 mesh fine gauze and then applied onto the glass substrate.

In one embodiment of the present invention, the drying is carried out at a temperature ranging from 20° C. to 160° C. for 4 to 12 hours, and thermal imidization is carried out at a temperature ranging from 100° C. to 350° C.

In one embodiment of the present invention, in the step S10, two kinds of the aromatic diamine monomers are dissolved in the polar aprotic organic solvent, and the two kinds of the aromatic diamine monomers have a molar ratio of 1:1 to 1:10.

In an embodiment of the present invention, in the step S20, the dianhydride monomer is added to the homogeneous solution, and a molar ratio of the dianhydride monomer to a sum of the two kinds of the aromatic diamine monomers is 1:0.5 to 1:1.

In an embodiment of the present invention, in the step S10, one kind of the aromatic diamine monomer is dissolved in the polar aprotic organic solvent; and in the step S20, two kinds of the dianhydride monomers are added to the homogeneous solution.

The present invention also provides a preparation method of another polyimide film, comprising the following steps:

step S10, dissolving at least one kind of aromatic diamine monomer in a polar aprotic organic solvent, adding a silane coupling agent, and stirring uniformly to form a homogeneous solution, wherein the aromatic diamine monomer has a molecular structural formula as shown in Formula (1):

H₂N—R₁—NH₂ (1)

step S20, adding at least one kind of dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2):

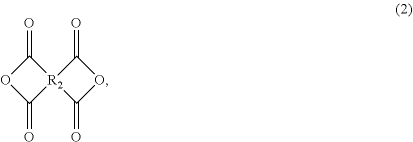

and the polyamic acid has a molecular structural formula as shown in Formula (3):

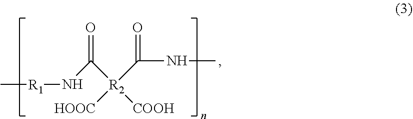

wherein n is a positive integer;

step S30, coating the polyamic acid solution on a glass substrate, followed by drying, and then carrying out thermal imidization under vacuum, and naturally cooling to room temperature to obtain the polyimide film, wherein the polyimide has a molecular structural formula as shown in formula (4):

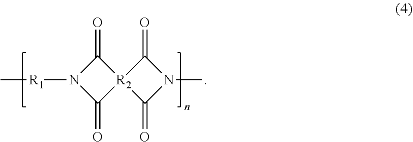

In an embodiment of the present invention, R1 is selected from one of the following molecular structural formulae:

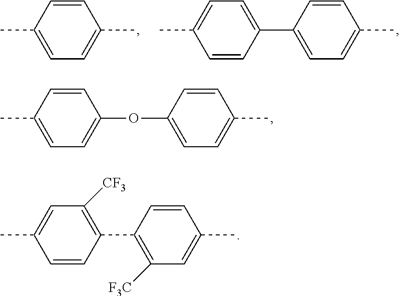

In an embodiment of the present invention, wherein R2 is selected from one of the following molecular structural formulae:

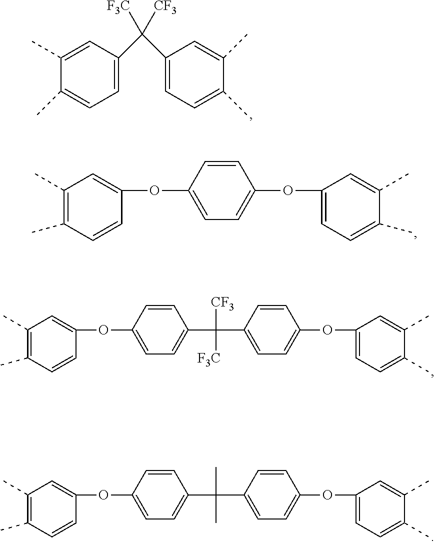

In an embodiment of the present invention, in the step S20, the dianhydride monomer is added to the homogeneous solution in 3 to 8 times, and the dianhydride monomer and the aromatic diamine monomer are reacted at room temperature for 8 to 20 hours.

In an embodiment of the present invention, in the step S30, in the step S30, the polyamic acid solution is filtered with a 300-500 mesh fine gauze and then applied onto the glass substrate.

In one embodiment of the present invention, the drying is carried out at a temperature ranging from 20° C. to 160° C. for 4 to 12 hours, and thermal imidization is carried out at a temperature ranging from 100° C. to 350° C.

In one embodiment of the present invention, in the step S10, two kinds of the aromatic diamine monomers are dissolved in the polar aprotic organic solvent, and the two kinds of the aromatic diamine monomers have a molar ratio of 1:1 to 1:10.

In an embodiment of the present invention, in the step S20, the dianhydride monomer is added to the homogeneous solution, and a molar ratio of the dianhydride monomer to a sum of the two kinds of the aromatic diamine monomers is 1:0.5 to 1:1.

In an embodiment of the present invention, in the step S10, one kind of the aromatic diamine monomer is dissolved in the polar aprotic organic solvent; and in the step S20, two kinds of the dianhydride monomers are added to the homogeneous solution.

The present invention also provides a display panel comprising a substrate, wherein the substrate is a polyimide film, and a method of preparing the polyimide film comprises the following steps:

Step S10, dissolving at least one aromatic diamine monomer in a polar aprotic organic solvent, adding a silane coupling agent, and stirring uniformly to form a homogeneous solution, wherein the aromatic diamine monomer has a molecular structural formula as shown in Formula (1):

H₂N—R₁—NH₂ (1)

Step S20, adding at least one dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2):

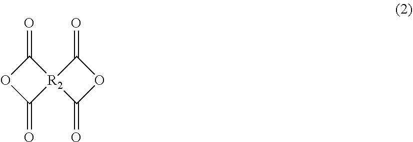

and the polyamic acid has a molecular structural formula as shown in Formula (3):

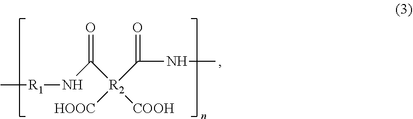

wherein n is a positive integer;

Step S30, coating the polyamic acid solution on a glass substrate, followed by drying, and then carrying out a thermal imidization under vacuum, and naturally cooling to room temperature to obtain the polyimide film, wherein the polyimide has a molecular structural formula as shown in formula (4):

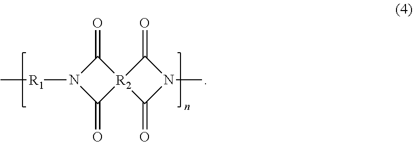

In an embodiment of the present invention, R1 is selected from one of the following molecular structural formulae:

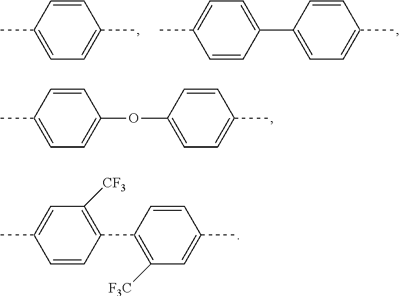

In an embodiment of the present invention, R2 is selected from one of the following molecular structural formulae:

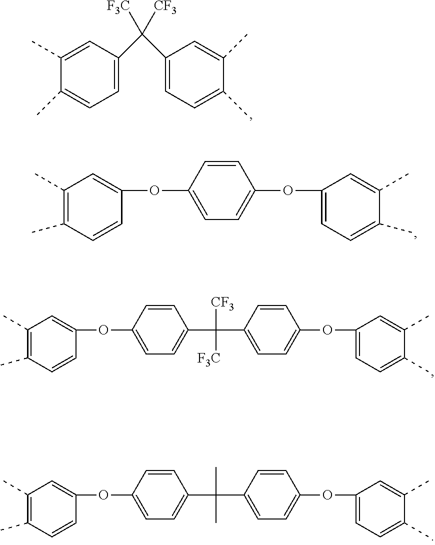

In an embodiment of the present invention, in the step S20, the dianhydride monomer is added to the homogeneous solution in 3 to 8 times, and the dianhydride monomer and the aromatic diamine monomer are reacted at room temp

The present invention has the beneficial effects that the present invention prepares a transparent polyimide material by copolymerization, introduces a silane coupling agent in the preparation process, uses a hydroxyl group formed by hydrolysis of the silane coupling agent and a hydroxyl group on the glass substrate (when a curing temperature rises), to carry out a dehydration reaction to form a chemical bond, and further employs this chemical bond acts to enhance the adhesion between the polyimide and the glass substrate, thereby improving the problem of separation of the two substrates due to poor adhesion.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these FIGURES without paying creative work.

FIG. 1 is a flow chart showing the steps of a method of preparing a polyimide film according to an embodiment of the present invention.

### DETAILED DESCRIPTION OF PREFERRED EMBODIMENTS

The following description of the various embodiments is provided to illustrate the specific embodiments of the invention. Directional terms mentioned in the present invention, such as “vertical”, “horizontal”, “upper”, “bottom”, “pre”, “post”, “left”, “right”, “inside”, “outside”, “side”, etc., only refer to the direction of the additional drawing. Therefore, the directional terminology used is for the purpose of illustration and understanding of the invention. In the FIGURES, structurally similar elements are denoted by the same reference numerals.

The present invention is directed to a method of preparing a polyimide film. When a polyimide film is prepared on a rigid substrate, the adhesion between the upper and lower substrates is poor, resulting in separation of the polyimide film from the rigid substrate, thereby impacting the performance problem of the polyimide film, and the following embodiment can solve such a defect.

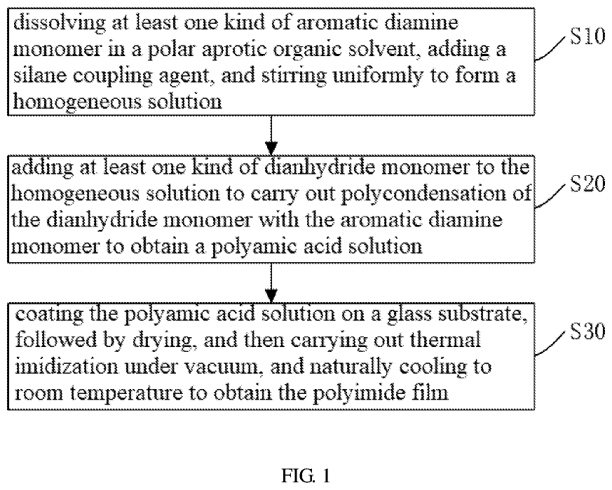

As shown in FIG. 1, an embodiment of the present invention provides a method of preparing a polyimide film, and the structural formula of the polyimide is as shown in Formula (4):

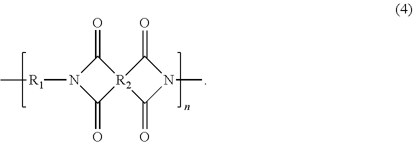

The polyimide is formed from a polyamic acid obtained by a polycondensation reaction of a diamine monomer and a dianhydride monomer, and a silane coupling agent is added to the system, and the silane coupling agent is hydrolyzed and reacts with the glass substrate to form a transparent polyimide film. A hydroxyl group formed by hydrolysis of the silane coupling agent and a hydroxyl group on the glass substrate (when a curing temperature rises) are used to carry out a dehydration reaction to form a chemical bond, and this chemical bond acts to enhance the adhesion between the polyimide and the glass substrate, thereby improving the problem of separation of the two substrates due to poor adhesion

For the flexible liquid crystal display (LCD) technology, a flexible substrate is usually attached to a rigid substrate (such as a glass substrate), and after the process is completed, the flexible substrate is peeled off from the rigid substrate. In order to avoid the risk of separation of the polyimide film from the substrate due to poor adhesion during the process, there is a high requirement for adhesion between the two substrates, and the flexible substrate is required to have excellent transmittance, and therefore, an embodiment of the present invention aims to improve the problem of poor adhesion between the transparent polyimide film and the rigid substrate.

In an embodiment of the present invention, the polyimide film is prepared by a two-step method, wherein by the two-step method, a polyamic acid precursor solution is first prepared, and a silane coupling agent is added to the polyamic acid solution to prepare a modified polyamic acid solution which is then coated on a glass substrate and finally subjected to a thermal curing by gradiently heating to obtain a modified transparent polyimide film. Preparation methods of enbodiments of the present invention are described in detail below.

Step S10, dissolving at least one aromatic diamine monomer in a polar aprotic organic solvent, adding a silane coupling agent, and stirring uniformly to form a homogeneous solution, wherein the aromatic diamine monomer has a molecular structural formula as shown in Formula (1):

H₂N—R₁—NH₂ (1)

Step S20, adding at least one dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2):

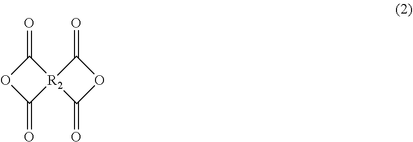

and the polyamic acid has a molecular structural formula as shown in Formula (3):

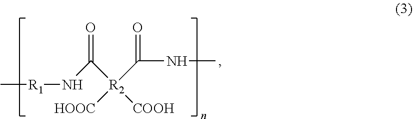

wherein n is a positive integer;

Step S30, coating the polyamic acid solution on a glass substrate, followed by drying, and then carrying out a thermal imidization under vacuum, and naturally cooling to room temperature to obtain the polyimide film, wherein the polyimide has a molecular structural formula as shown in formula (4):

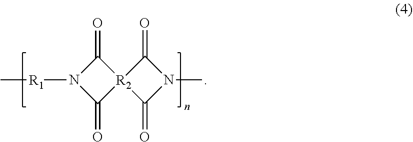

R1 is selected from one of the following molecular structural formulae:

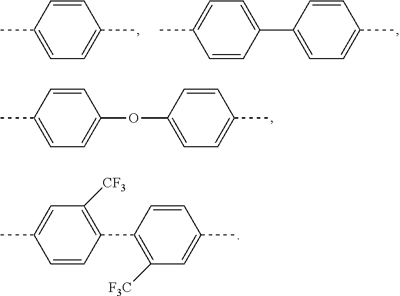

R2 is selected from one of the following molecular structural formulae:

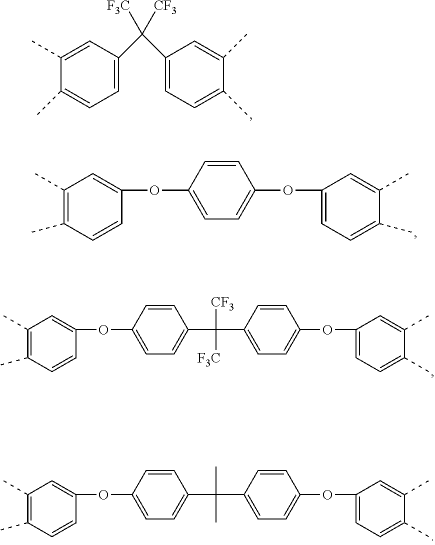

First, the aromatic diamine monomers having any two of the above structural formulas respectively are dissolved in the polar aprotic organic solvent under a protective atmosphere of an inert gas (for example, nitrogen), and a certain amount of the silane coupling agent is added, followed by uniformly stirring to form the homogeneous solution. The two kinds of the aromatic diamine monomers have a molar ratio of 1:1 to 1:10.

The polar aprotic organic solvent is one of N,N-dimethylacetamide, N,N-dimethylformamide, dimethyl sulfoxide, and N-methylpyrrolidone.

Thereafter, the same dianhydride monomers is added to the homogeneous solution in 3-8 times, that is added in batches to facilitate uniform mixing of the solution, and reacted at room temperature for 8 to 20 hours to obtain the polyamic acid solution, wherein a molar ratio of the dianhydride monomer to a sum of the two kinds of the aromatic diamine monomers is 1:0.5 to 1:1.

Next, the obtained polyamic acid solution is filtered with a 300-500 mesh fine gauze to remove impurities, then applied onto the glass substrate, dried at 20° C. to 160° C. for 4 hours to 12 hours, and thermal imidization is carried out at a temperature ranging from 100° C. to 350° C., that is, a gradient heating reaction, and finally, naturally cooing to room temperature to obtain a transparent polyimide film.

The reaction scheme of the aromatic diamine monomers and the dianhydride monomer for synthesizing the polyimide film is as follows:

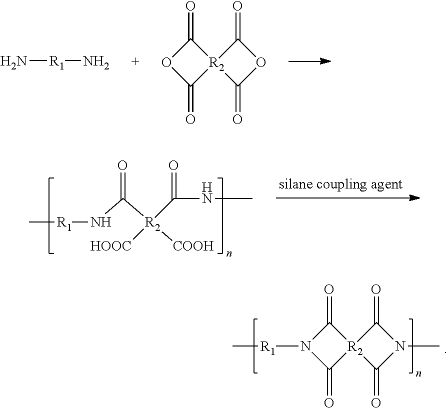

In this embodiment, two kinds of aromatic diamine monomers are selected to react with one kind of dianhydride monomer. In other embodiments, one kind of aromatic diamine monomer can be selected to react with two kinds of dianhydride monomers. In other embodiments, the order of addition of the aromatic diamine monomer and the dianhydride monomer may also be changed, for example, first adding the dianhydride monomer, and then adding the aromatic diamine monomer. Since comprehensive properties such as transparency and mechanical properties of the transparent polyimide film needs to be taken into consideration, if only one kind of aromatic diamine monomer and one kind of dianhydride monomer are selected, it is difficult to simultaneously achieve both transparency and mechanical properties.

Chemical bonding principle of the silane coupling agent is shown in the scheme below. The silane coupling agent reacts with the polyamic acid to form a chemical bond, and the silane coupling agent is hydrolyzed to form a hydroxyl group. When a temperature for the heat curing raises, the hydroxyl group on the silane coupling agent and the hydroxyl group on the glass substrate are dehydrated to form a chemical bond, so that the cured polyimide film is connected to the glass substrate, thereby improving adhesion between the two materials.

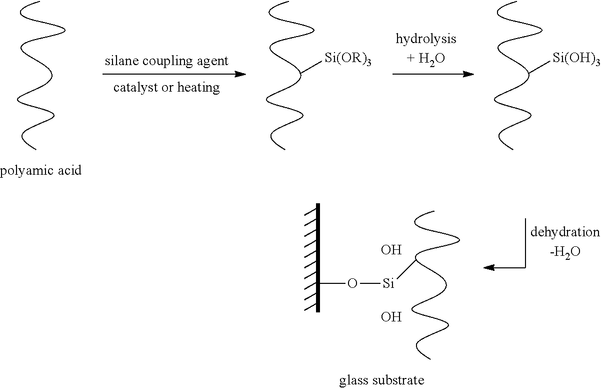

However, the polyamic acid solution has a certain viscosity, which tends to cause uneven dispersion of the silane coupling agent, resulting in poor uniformity of the polyimide film layer. In order to improve the dispersion of the silane coupling agent in the polyamic acid solution, in an embodiment of the present invention, the silane coupling agent is directly introduced in the monomer stage, that is, after adding the aromatic diamine monomer (or the dianhydride monomer) to the solvent, the silane coupling agent is directly added to the system, followed by thorough stirringl, and then the dianhydride monomer (or the aromatic diamine monomer) is further added thereto.

An embodiment of the present invention further provides a display panel, which includes a substrate, a thin film transistor array, and a display layer. The display layer may be a light emitting layer of an organic light-emitting diode (OLED) or a liquid crystal display layer. and details are not described herein for brevity. The substrate is a transparent polyimide film which is prepared by the above method.

The present invention has the beneficial effects that the present invention prepares a transparent polyimide material by copolymerization, introduces a silane coupling agent in the preparation process, uses a hydroxyl group formed by hydrolysis of the silane coupling agent and a hydroxyl group on the glass substrate (when a curing temperature rises), to carry out a dehydration reaction to form a chemical bond, and further employs this chemical bond to enhance the adhesion between the polyimide and the glass substrate, thereby improving the problem of separation of the two substrates due to poor adhesion.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

What is claimed is:

1. A method for preparing a polyimide film, comprising the following steps:
step S10, dissolving at least one kind of aromatic diamine monomer in a polar aprotic organic solvent, adding a silane coupling agent, and stirring uniformly to form a homogeneous solution, wherein the aromatic diamine monomer has a molecular structural formula as shown in Formula (1):
H₂N—R₁—NH₂ (1)
step S20, adding at least one dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2): 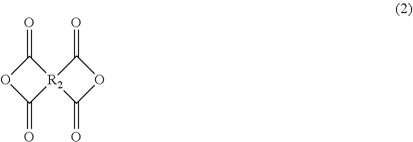
and the polyamic acid has a molecular structural formula as shown in Formula (3): 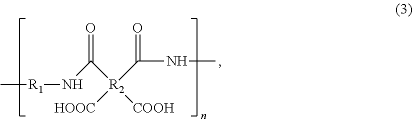
wherein n is a positive integer;
step S30, coating the polyamic acid solution on a glass substrate, followed by drying, and then carrying out thermal imidization under vacuum, and naturally cooling to room temperature to obtain the polyimide film, wherein the polyimide has a molecular structural formula as shown in formula (4): 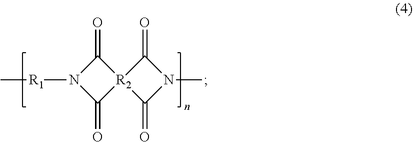
R₁ is selected from one of the following molecular structural formulae: 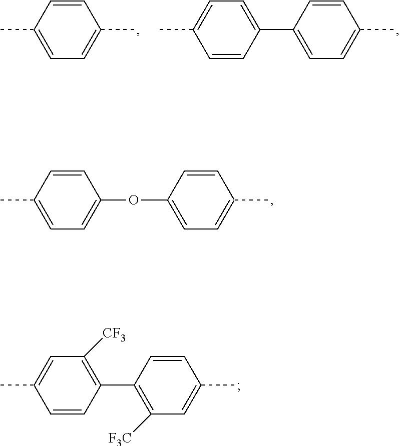
R₂ is selected from one of the following molecular structural formulae:

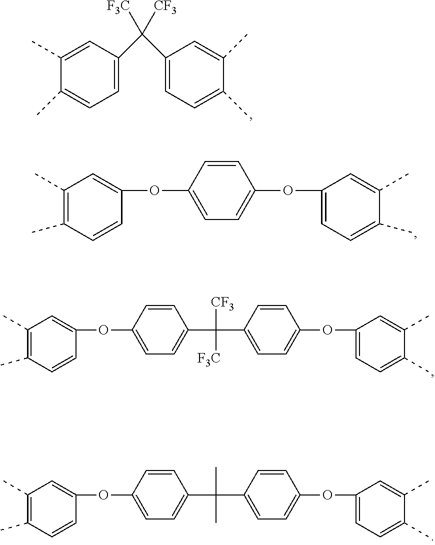

2. The preparation method according to claim 1, wherein in the step S20, the dianhydride monomer is added to the homogeneous solution in 3 to 8 times, and the dianhydride monomer and the aromatic diamine monomer are reacted at room temperature for 8 to 20 hours.

3. The preparation method according to claim 1, wherein in the step S30, the polyamic acid solution is filtered with a 300-500 mesh fine gauze and then applied onto the glass substrate.

4. The preparation method according to claim 3, wherein the drying is carried out at a temperature ranging from 20° C. to 160° C. for 4 to 12 hours, and thermal imidization is carried out at a temperature ranging from 100° C. to 350° C.

5. The method according to claim 1, wherein in the step S10, two kinds of the aromatic diamine monomers are dissolved in the polar aprotic organic solvent, and the two kinds of the aromatic diamine monomers have a molar ratio of 1:1 to 1:10.

6. The preparation method according to claim 5, wherein in the step S20, the dianhydride monomer is added to the homogeneous solution, and a molar ratio of the dianhydride monomer to a sum of the two kinds of the aromatic diamine monomers is 1:0.5 to 1:1.

7. The preparation method according to claim 1, wherein in the step S10, one kind of the aromatic diamine monomer is dissolved in the polar aprotic organic solvent; and in the step S20, two kinds of the dianhydride monomers are added to the homogeneous solution.

8. A method of preparing a polyimide film comprising the following steps:
step S10, dissolving at least one kind of aromatic diamine monomer in a polar aprotic organic solvent, adding a silane coupling agent, and stirring uniformly to form a homogeneous solution, wherein the aromatic diamine monomer has a molecular structural formula as shown in Formula (1):
H₂N—R₁—NH₂ (1)
step S20, adding at least one kind of dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2): 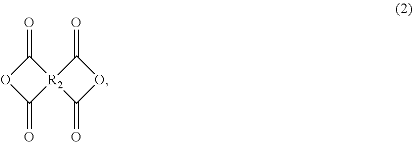
and the polyamic acid has a molecular structural formula as shown in Formula (3): 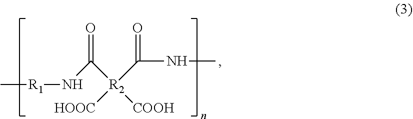
wherein n is a positive integer;
step S30, coating the polyamic acid solution on a glass substrate, followed by drying, and then carrying out thermal imidization under vacuum, and naturally cooling to room temperature to obtain the polyimide film, wherein the polyimide has a molecular structural formula as shown in formula (4):

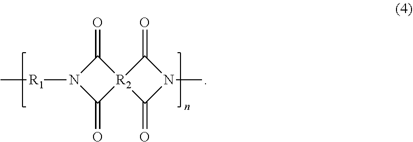

9. The preparation method according to claim 8, wherein R₁ is selected from one of the following molecular structural formulae:

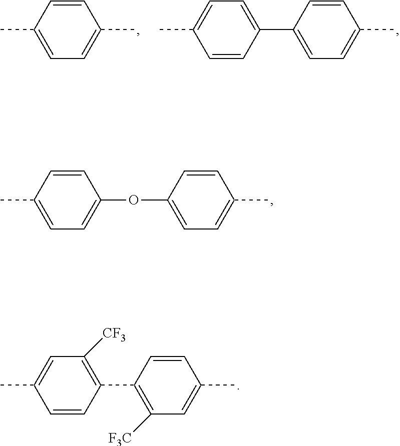

10. The preparation method according to claim 8, wherein R₂ is selected from one of the following molecular structural formulae:

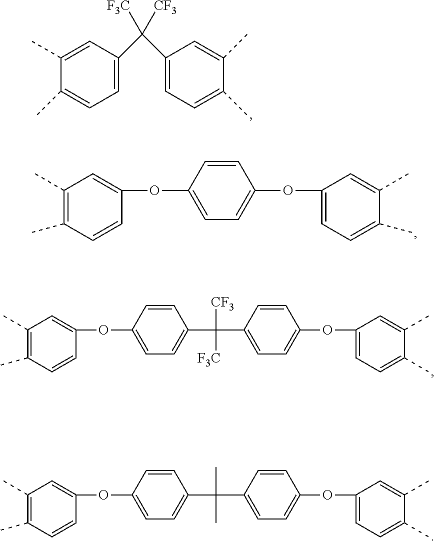

11. The preparation method according to claim 8, wherein in the step S20, the dianhydride monomer is added to the homogeneous solution in 3 to 8 times, and the dianhydride monomer and the aromatic diamine monomer are reacted at room temperature for 8 to 20 hours.

12. The preparation method according to claim 8, wherein in the step S30, the polyamic acid solution is filtered with a 300-500 mesh fine gauze and then applied onto the glass substrate.

13. The preparation method according to claim 12, wherein the drying is carried out at a temperature ranging from 20° C. to 160° C. for 4 to 12 hours, and thermal imidization is carried out at a temperature ranging from 100° C. to 350° C.

14. The method according to claim 8, wherein in the step S10, two kinds of the aromatic diamine monomers are dissolved in the polar aprotic organic solvent, and the two kinds of the aromatic diamine monomers have a molar ratio of 1:1 to 1:10.

15. The preparation method according to claim 14, wherein in the step S20, the dianhydride monomer is added to the homogeneous solution, and a molar ratio of the dianhydride monomer to a sum of the two kinds of the aromatic diamine monomers is 1:0.5 to 1:1.

16. The preparation method according to claim 8, wherein in the step S10, one kind of the aromatic diamine monomer is dissolved in the polar aprotic organic solvent; and in the step S20, two kinds of the dianhydride monomers are added to the homogeneous solution.

17. A display panel, comprising a substrate, wherein the substrate is a polyimide film, and a method of preparing the polyimide film comprises the following steps:
Step S10, dissolving at least one aromatic diamine monomer in a polar aprotic organic solvent, adding a silane coupling agent, and stirring uniformly to form a homogeneous solution, wherein the aromatic diamine monomer has a molecular structural formula as shown in Formula (1):
H₂N—R₁—NH₂ (1)
Step S20, adding at least one dianhydride monomer to the homogeneous solution to carry out polycondensation of the dianhydride monomer with the aromatic diamine monomer to obtain a polyamic acid solution, wherein the dianhydride monomer has a molecular structural formula as shown in Formula (2): 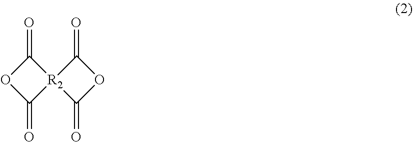
and the polyamic acid has a molecular structural formula as shown in Formula (3): 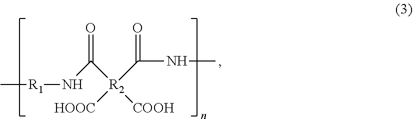
wherein n is a positive integer;
Step S30, coating the polyamic acid solution on a glass substrate, followed by drying, and then carrying out a thermal imidization under vacuum, and naturally cooling to room temperature to obtain the polyimide film, wherein the polyimide has a molecular structural formula as shown in formula (4):

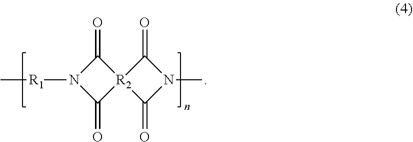

18. The display panel according to claim 17, wherein R₁ is selected from one of the following molecular structural formulae:

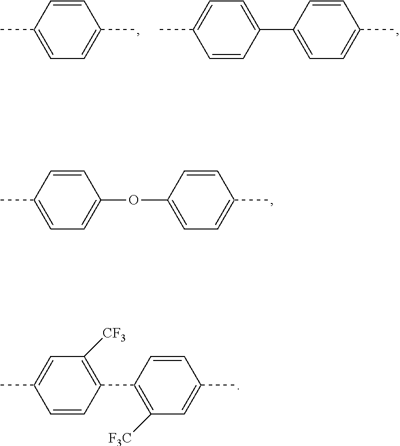

19. The display panel according to claim 17, wherein R₂ is selected from one of the following molecular structural formulae:

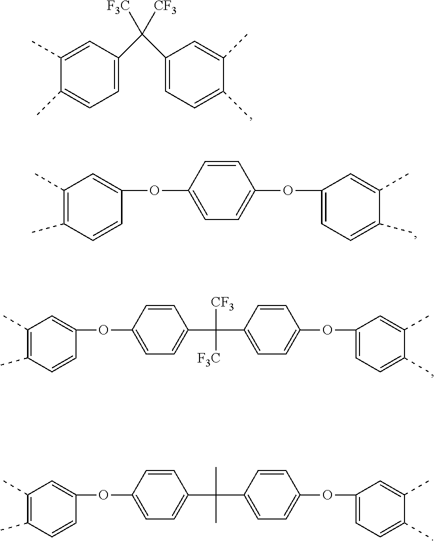

20. The display panel according to claim 17, wherein in the step S20, the dianhydride monomer is added to the homogeneous solution in 3 to 8 times, and the dianhydride monomer and the aromatic diamine monomer are reacted at room temperature for 8 to 20 hours.
